(19) United States
(12) Patent Application Publication
(10) Pub. No.: US 2012/0195390 A1
(43) Pub. Date: Aug. 2, 2012

(54) Processing method and system of demodulate reference signal, base station, user equipment

(75) Inventors: Wenhao Liu, Shenzhen (CN); Yanwen Wang, Shenzhen (CN); Jing Jiang, Shenzhen (CN); Qinghong Zhang, Shenzhen (CN)

(73) Assignee: ZTE CORPORATION, Shenzhen, Guangdong (CN)

(21) Appl. No.: 13/259,041

(22) PCT Filed: Mar. 25, 2010
(86) PCT No.: PCT/CN2010/071302

§ 371 Date: Mar. 21, 2012

(30) Foreign Application Priority Data
Sep. 24, 2009 (CN) 200910093462.1

(51) Int. Cl. H04L 27/06; H04L 27/28

(52) U.S. Cl. 375/260; 375/340

(57) ABSTRACT

The present disclosure discloses a processing method and system, configuring method, and demodulating method of demodulate reference signal, a base station and a UE. The base station configures common reference signals on control symbols and user-dedicated reference signals on service symbols; the UE demodulates control information by using the common reference signals and demodulates service data and broadcast data by using the user-dedicated reference signals, wherein the control symbols are OFDM symbols carrying the control information, and the service symbols are OFDM symbols without carrying the control information. With the application of the present disclosure, the purpose of reducing the overhead of reference signals can be achieved.

### TECHNICAL FIELD

The present disclosure relates to the field of communications, particularly to a processing method and system of demodulate reference signal, a base station and a user equipment.

### BACKGROUND

At present, demodulation of broadcast information and control information in a Long Term Evolution (LTE) system is achieved by a common reference signal. In order to guarantee reliable transmission of control information, the LTE system can transmit control data in the manner of Space-Frequency Block Code (SFBC) or in the manner of SFBC combined with Frequency Switched Transmit Diversity (SFBC+FSTD).

During transmission of service data, a service channel can transmit the service data in the manner of transmit diversity, spatial multiplexing or Beam Forming (BF). If the spatial multiplexing or transmit diversity is applied by the service channel, a User Equipment (UE) needs to use a common reference signal of a cell to demodulate the service data. If the service channel applies the manner of BF, the UE can utilize an existing user-dedicated reference signal to demodulate the service data.

In practical applications, with the increase of transmitting antennas, the overheard of reference signals is correspondingly increased. Taking a 4-antenna reference signal pattern in the LTE system as an example, the proportion of the overhead of reference signals in every Resource Block (RB) is 14.29%. If reference signals of 8 antennas are extended in this way, the overhead of the reference signals will be increased and the resources applied to data transmission will be correspondingly reduced, thus influencing the data transmission efficiency of the whole system. Increasing the number of user-dedicated reference signals to realize reference signal transmission will also result in extra overhead of reference signals. Taking a 4-antenna port as an example, the overhead of reference signals may account for as much as 21.43% of a total overhead. In addition, in the case that the service channel transmits service data in the manner of the spatial multiplexing, there is no change in the overhead of reference signals when the channel does not have sufficient separability. Therefore, such reference signal design bound with the number of antennas cannot take a specific spatial channel into consideration, which is bad in flexibility and increases the overhead of reference signals, thereby reducing the transmission efficiency.

Currently, there is no effective solution for solving the problem of low data transmission efficiency caused by large transmission overhead of reference signals in relevant technologies.

### SUMMARY

In order to solve the problem of low data transmission efficiency caused by large transmission overhead of reference signals in relevant technologies, the present disclosure provides a configuring method of demodulate reference signal, which can reduce the overhead of reference signals.

In order to solve the problem of low data transmission efficiency caused by large transmission overhead of reference signals in relevant technologies, the present disclosure further provides a demodulation method of demodulate reference signal, which can reduce the overhead of reference signals.

In order to solve the problem of low data transmission efficiency caused by large transmission overhead of reference signals in relevant technologies, the present disclosure further provides a base station, which can reduce the overhead of reference signals.

In order to solve the problem of low data transmission efficiency caused by large transmission overhead of reference signals in relevant technologies, the present disclosure further provides a UE, which can reduce the overhead of reference signals.

In order to solve the problem of low data transmission efficiency caused by large transmission overhead of reference signals in relevant technologies, the present disclosure further provides a processing method of demodulate reference signal, which can reduce the overhead of reference signals.

In order to solve the problem of low data transmission efficiency caused by large transmission overhead of reference signals in relevant technologies, the present disclosure further provides a processing system of demodulate reference signal, which can reduce the overhead of reference signals.

The technical solutions of the present disclosure are realized as follows.

The present disclosure provides a configuring method of demodulate reference signal, including:

configuring, by a base station, common reference signals on control symbols and user-dedicated reference signals on service symbols;

wherein the control symbols are Orthogonal Frequency Division Multiplexing (OFDM) symbols carrying control information, and the service symbols are OFDM symbols without carrying control information.

The method may further include: making, by the base station, a control channel for transmitting the control information carried on the control symbols.

Furthermore, an interval between neighboring user-dedicated reference signals on a same sub-carrier may be N OFDM symbols, wherein N is 4, 5, 6 or 7;

a minimal interval between user-dedicated reference signals on a same OFDM symbol or different OFDM symbols may be M sub-carriers, wherein M=3 or 4.

The method may further include: making, by the base station, a broadcast channel for transmitting broadcasting information and a service channel for transmitting service data carried on the service symbols.

The method may further include: when the user-dedicated reference signals are configured on the service symbols, configuring a number of layers of the user-dedicated reference signals as same as a number of channel layers for transmitting the service data in the service channel to obtain layered user-dedicated reference signals, and using the layered user-dedicated reference signals to demodulate the service data and the broadcast information.

The method may further include: configuring by the base station a channel identifier for the broadcast channel, wherein the channel identifier can be scrambled by the base station.

Further, the channel identifier may be a radio network temporary identifier.

The present disclosure further provides a demodulating method of demodulate reference signal, including:

demodulating, by a UE, control information by using common reference signals configured on control symbols, and demodulating service data and broadcast data by using user-dedicated reference signals configured on service symbols;

wherein the control symbols are OFDM symbols carrying control information and the service symbols are OFDM symbols without carrying control information.

The method may further include: using, by the UE, a channel identifier of a broadcast channel to descramble broadcast information carried on the service symbols to receive the broadcast information.

The present disclosure further provides a processing method of demodulate reference signal, including:

configuring, by a base station, common reference signals on control symbols and user-dedicated reference signals on service symbols;

demodulating, by a UE, control information by using the common reference signals and demodulating service data and broadcast data by using the user-dedicated reference signals;

wherein the control symbols are OFDM symbols carrying control information and the service symbols are OFDM symbols without carrying control information.

The present disclosure further provides a base station, including:

a first configuration module for configuring common reference signals on control symbols;

a second configuration module for configuring user-dedicated reference signals on service symbols, and making a broadcast channel and a service channel carried on the service symbols, wherein the broadcast channel is configured to transmit broadcast information and the service channel is configured to transmit service data;

wherein the control symbols are OFDM symbols carrying control information and the service symbols are OFDM symbols without carrying control information.

Further, an interval between neighboring user-dedicated reference signals on a same sub-carrier may be N OFDM symbols, wherein N=4,5, 6 or 7;

a minimal interval between user-dedicated reference signals on a same OFDM symbol or different OFDM symbols may be M sub-carriers, wherein M=3 or 4.

The present disclosure further provides a UE, including:

a first processing module for demodulating control information by using common reference signals configured on control symbols;

a second processing module for demodulating service data and broadcast information by using user-dedicated reference signals configured on service symbols;

wherein the control symbols are OFDM symbols carrying control information and the service symbols are OFDM symbols without carrying control information.

The present disclosure further provides a processing system of demodulate reference signal, including a base station and a UE, wherein

the base station is configured to configure common reference signals on control symbols and user-dedicated reference signals on service symbols, and the base station includes:
a first configuration module for configuring the common reference signals on the control symbols;
a second configuration module for configuring the user-dedicated reference signals on the service symbols, and making a broadcast channel and a service channel carried on the service symbols;

the UE configured to demodulate control information by using the common reference signals, and to demodulate service data and broadcast data by using the user-dedicated reference signals, and the UE includes:
a first processing module for demodulating the control information by using the common reference signals configured on the control symbols;
a second processing module for demodulating the service data and broadcast information by using the user-dedicated reference signals configured on the service symbols;

wherein the control symbols are OFDM symbols carrying control information and the service symbols are OFDM symbols without carrying control information.

With at least one aforementioned technical solution of the present disclosure, the objective of reducing the overhead of reference signals can be achieved by respectively designing the reference signals on the service symbols and that on the control symbols. In addition, the reference signals on the broadcast channel and the reference signals on the service channel are designed uniformly, so that the design of the reference signals on the service symbols is simplified, and the overhead of reference signals is reduced while the transmit diversity performance is not evidently reduced for the virtual antenna mapping technology.

### BRIEF DESCRIPTION OF THE DRAWINGS

FIG. 1 shows a flowchart of a configuring method of demodulate reference signal according to an embodiment of the present disclosure;

FIG. 2 shows a flowchart of a demodulation method of demodulate reference signal according to an embodiment of the present disclosure;

FIG. 3 shows a transmit diversity scheme using virtual antenna port mapping according to an embodiment of the present disclosure;

FIG. 4a shows a schematic diagram of a reference signal mapping pattern of antenna port 0 according to example 1 of the present disclosure;

FIG. 4b shows a schematic diagram of a reference signal mapping pattern of antenna port 1 according to example 1 of the present disclosure;

FIG. 5 shows a schematic diagram of time-frequency resources occupied by broadcast information according to an embodiment of the present disclosure;

FIG. 6a shows a schematic diagram of a reference signal mapping pattern of antenna port 0 according to example 2 of the present disclosure;

FIG. 6b shows a schematic diagram of a reference signal mapping pattern of antenna port 1 according to example 2 of the present disclosure;

FIG. 7a shows a schematic diagram of a reference signal mapping pattern of antenna port 0 according to example 3 of the present disclosure; FIG. 7b shows a schematic diagram of a reference signal mapping pattern of antenna port 1 according to example 3 of the present disclosure;

FIG. 8a shows a schematic diagram of a reference signal mapping pattern of antenna port 0 according to example 4 of the present disclosure;

FIG. 8b shows a schematic diagram of a reference signal mapping pattern of antenna port 1 according to example 4 of the present disclosure;

FIG. 9a shows a schematic diagram of a reference signal mapping pattern of antenna port 0 according to example 5 of the present disclosure;

FIG. 9b shows a schematic diagram of a reference signal mapping pattern of antenna port 1 according to example 5 of the present disclosure; FIG. 9c shows a schematic diagram of a reference signal mapping pattern of antenna port 2 according to example 5 of the present disclosure;

FIG. 9d shows a schematic diagram of a reference signal mapping pattern of antenna port 3 according to example 5 of the present disclosure;

FIG. 10 shows a structure block diagram of a base station according to an embodiment of the present disclosure;

FIG. 11 shows a structure block diagram of a user equipment according to an embodiment of the present disclosure; and

FIG. 12 shows a structure block diagram of a processing system of demodulate reference signal according to an embodiment of the present disclosure.

### DETAILED DESCRIPTION

A processing method of demodulate reference signal of the present disclosure is: taking OFDM symbols carrying control information as control symbols, wherein the number of the OFDM symbols is notified by a Physical Control Format Indicator Channel (PCFICH); taking the remaining OFDM symbols (i.e. the OFDM symbols without carrying control information) as service symbols; configuring common reference signals on the control symbols and configuring user-dedicated reference signals on the service symbols to effectively reduce the overhead of the reference signals and correspondingly increase the data transmission efficiency of the system. A processing procedure of the present disclosure is described hereinafter from two aspects, i.e. reference signal configuration and reference signal demodulation.

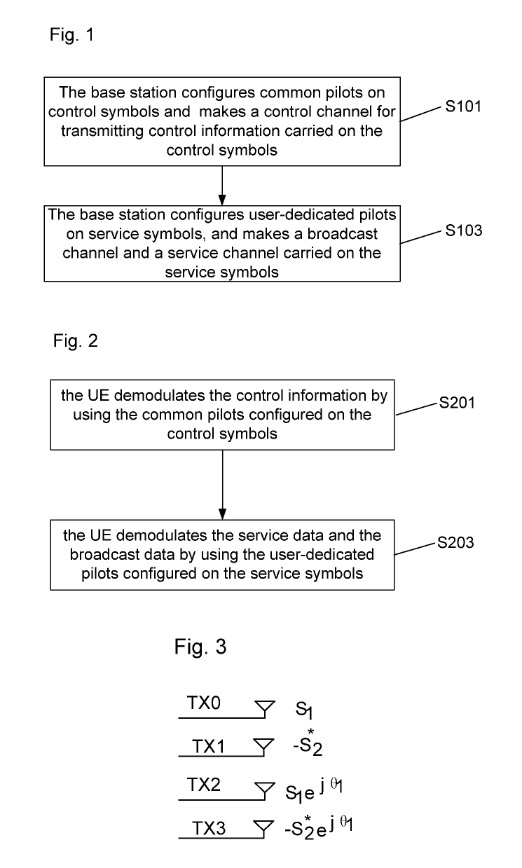

FIG. 1 shows a flowchart of a configuring method of demodulate reference signal according to an embodiment of the present disclosure. This flow is performed on a base station side. As shown in FIG. 1, the configuring method of demodulate reference signal of the present disclosure comprises:

step S101: the base station configures common reference signals on control symbols and makes a control channel for transmitting control information carried on the control symbols;

during a specific implementation process, the base station may place control information on some OFDM symbols and the number of the OFDM symbols carrying control information may be varied according to actual need, in this way, the OFDM symbols carrying control information, i.e. the control symbols, can be determined, and common reference signals are configured on the control symbols, wherein the pattern of the common reference signals can apply the patterns of existing common reference signals at antenna ports;

step S103: the base station configures user-dedicated reference signals on service symbols, and makes a broadcast channel and a service channel carried on the service symbols;

wherein the broadcast channel is used for transmitting broadcast information and the service channel is used for transmitting service data; when configuring user-dedicated reference signals on the service symbols, the following configuration rules may be applied: an interval between neighboring user-dedicated reference signals on the same sub-carrier is N OFDM symbols, wherein N=4, 5, 6 or 7; the minimal interval between user-dedicated reference signals on the same or different OFDM symbols is M sub-carriers, wherein M=3 or 4. Here only relative locations of all user-dedicated reference signals are specified. Every specific downlink-dedicated location can be flexibly configured according to the need, as long as the relative locations of all user-dedicated reference signals satisfy the aforementioned rules.

The broadcast channel can be configured with a channel identifier. For example, a Radio Network Temporary Identifier (RNTI) can be used as an identifier of the broadcast channel. The channel identifier is sent to the base station and the user so that the base station can perform scrambling on the channel identifier.

In actual applications, transmission methods of the broadcast channel, the control channel and the service channel can be different to a certain extent. Specifically, the broadcast channel and the control channel are transmitted in the manner of transmit diversity and the service channel is sent in the manner of transmit diversity or spatial multiplexing. The broadcast channel and the service channel should be transmitted on the service symbols. Preferably, in the present disclosure, the base station configures layered user-dedicated reference signals on the service symbols: the number of layers of the user-dedicated reference signals can be equal to the number of channel layers for transmitting service data in the service channel, that is, the service data can be transmitted in the manner of spatial multiplexing or transmit diversity. In addition, the reference signal design for spatial multiplexing is related to the number of separable layers of the spatial channel. In the case that the transmit diversity is applied, the service data can be transmitted in the manner of virtual antenna mapping, and control information can be transmitted in the manner of transmit diversity, moreover, the reference signal is related to an antenna port (or a virtual antenna port).

By the aforementioned reference signal configuration scheme, the overhead of reference signals is reduced to a certain extent. More specifically, the comparison of overhead of reference signals of 4 transmitting antennas between traditional LTE and the present disclosure is as shown in Table 1 (control data are transmitted by two antenna ports):

TABLE 1

| | | Overhead of reference signals | |
|---|---|---|---|
| Transmission | The number of | Traditional | The present |
| manner | transmission layers | LTE | disclosure |
| Transmit diversity | 1 | 24/168 | 20/168 + 0.01 |
| Spatial multiplexing | 4 | 24/168 | 20/168 + 0.01 |
| Spatial multiplexing | 2 | 24/168 | 20/168 + 0.01 |
| Spatial multiplexing | 1 | 24/168 | 20/168 + 0.01 |
| BF | 1 | 36/128 | 20/168 + 0.01 |
| BF | 2 | Not support | 20/168 + 0.01 |

In Table 1, the “0.01” in an improved overhead of reference signals of the present disclosure is an overhead reserved for measuring a reference signal (actual overhead is smaller than 0.01). In addition, as shown in Table 1, the overhead of reference signals is determined according to the number of separable layers so that the BF of multiple streams can be supported to overcome the shortage of the LTE that it only supports the BF of a single stream, thus avoiding the problem that the fixed reference signal pattern in relevant technologies is only related to the number of antennas which influences the flexibility of reference signal configuration.

It can be seen that the present disclosure respectively designs reference signals on service symbols and on control symbols to make overhead of reference signals reduced. Further, the design of reference signals on the service symbols can be simplified by uniformly designing reference signals of the broadcast channel and the service channel. By applying the configuring method of demodulate reference signal of the present disclosure, control information is demodulated still by common reference signals, while service data (broadcast information can be taken as special service data in the service symbols, namely the data received by every UE) are demodulated by layered user-dedicated reference signals, thus reducing the overhead of reference signals without evidently reducing the transmit diversity performance of the virtual antenna mapping technology. Therefore, the broadcast channel and the control channel apply relatively fixed virtual antenna mapping manner (e.g. 2 antenna ports and 4 antenna ports) to realize transmit diversity. The broadcast channel and the control channel can be SFBC or SFBC+ Phase Shift Diversity (PSD), or other forms. The reference signal pattern of the RB where the broadcast channel is located is the same as the reference signal pattern of the RB where the service data are located.

FIG. 2 shows a flowchart of a demodulation method of demodulate reference signal according to an embodiment of the present disclosure. The flow is performed on a UE side. As shown in FIG. 2, the demodulation method of demodulate reference signal comprises:

step S201: the UE demodulates control information by using common reference signals configured on control symbols;

step S203: the UE demodulates service data and broadcast data by using user-dedicated reference signals configured on service symbols.

Furthermore, when the reference signal demodulation is performed, a base station can perform scrambling on a broadcast channel identifier during reference signal transmission, therefore, the UE needs to descramble the broadcast channel identifier of the broadcast channel carried on the service symbols when it receives the reference signals. For example, a common RNTI is used as a channel identifier of the broadcast channel, the common RNTI is known to all UEs, and each UE uses the common RNTI to perform descrambling.

In addition, for the receiving side, the UE obtains transmitted data of all physical antennas without need of splitting data while only needing to estimate a comprehensive Hnm (n is the number of a receiving antenna and m is the port number of a transmitting antenna) by using the reference signals. For example, Hn1 is corresponding to the comprehensive channel response of Tx0 and Tx3, i.e. hₙ₁=hₙ₁+hₙ₃e^{jθ}^{₁} and then Alamouti decoding is performed. In this way, the UE can receive broadcast information and control information by using a diversity receiving method involving two antennas of the LTE, e.g. the diversity receiving method involving 2 virtual antennas as shown in FIG. 3.

According to the aforementioned embodiment, the present disclosure further provides a processing method of demodulate reference signal, comprising:

a base station configures common reference signals on control symbols and configures user-dedicated reference signals on service symbols; the UE demodulates control information by using the common reference signals and demodulates service data and broadcast data by using the user-dedicated reference signals;

wherein the control symbols are Orthogonal Frequency Division Multiplexing (OFDM) symbols carrying control information, and the service symbols are OFDM symbols without carrying control information.

The configuration and demodulation processes of demodulate reference signal of the present disclosure are described hereinafter with examples.

### EXAMPLE 1

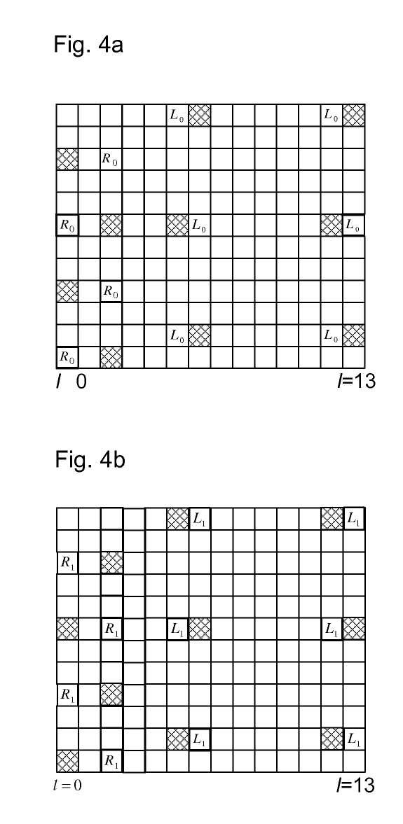

FIG. 4a shows a schematic diagram of a reference signal mapping pattern of antenna port 0, and FIG. 4b shows a schematic diagram of a reference signal mapping pattern of antenna port 1.

As shown in FIG. 4a, R₀ represents a common reference signal of antenna port 0, L₀ represents a dedicated reference signal of layer 0 of a user, the number of OFDM symbols for transmitting control information is 3, that is, the number of control symbols is 3, and the number of service symbols is 11, wherein the control symbols are OFDM symbols numbered with l=0, 1, 2, and the service symbols are OFDM symbols numbered with l=3˜13. In addition, L₀ is used for demodulating broadcast data and service data, the antenna port 0 carries the user-dedicated reference signals of the layer 0. Since the number of layers of the user-dedicated reference signals is configured the same as the number of channel layers used for transmitting service data in the service channel, a base station transmits data of the service channel by using the layer 0 and layer 1. In addition, it can be seen from FIG. 4a that the interval between neighboring user-dedicated reference signals on the same sub-carrier is 6 OFDM symbols. The minimal interval between user-dedicated reference signals on the same OFDM symbol or different OFDM symbols is 4 sub-carriers.

As shown in FIG. 4b, R₁ represents a common reference signal of antenna port 1, L₁ represents a user-dedicated reference signal, the number of OFDM symbols for transmitting control information is 3, that is, the number of control symbols is 3, and the number of service symbols is 11, wherein the control symbols are OFDM symbols numbered with l=0, 1, 2, and the service symbols are OFDM symbols numbered with l=3˜13. The user-dedicated reference signals L₀ and L₁ are used for demodulating broadcast data and service data of layer 0 and layer 1. The number of layer of user-dedicated reference signals of the antenna port 0 is 1. Since the number of layers of the user-dedicated reference signals is configured the same as the number of channel layers for transmitting service data in the service channel, a base station transmits data of the service channel by using layer 0 and layer 1. In addition, it can be seen from FIG. 4b that the interval between neighboring user-dedicated reference signals on the same sub-carrier is 6 OFDM symbols. The minimal interval between user-dedicated reference signals on the same OFDM symbol or different OFDM symbols is 4 sub-carriers.

In this example, the number of the OFDM symbols for transmitting control information is 3 and the number of layers for transmitting service data is 2 (antenna port 0 and antenna port 1 respectively use one layer of the service channel to transmit service data). The reference signals on the service symbols are in the form of frequency division multiplexing. For example, the number of transmitting antennas is 4, the service data is transmitted in the manner of transmit diversity and the control information is transmitted in the manner of transmit diversity, the Physical Control Format Indicator Channel (PCFICH) notifies a current sub-frame that there are 3 OFDM symbols for transmitting control information, and both the number of channel layers for transmitting service data and that for transmitting broadcast data are two, in this way, the specific steps for realizing reference signal configuration and demodulation are as follows:

step 1: a sender (e.g. a base station) maps a reference signal sequence (common reference signals and user-dedicated reference signals) to corresponding time-frequency resources according to the reference signal patterns of FIG. 4a and FIG. 4b;

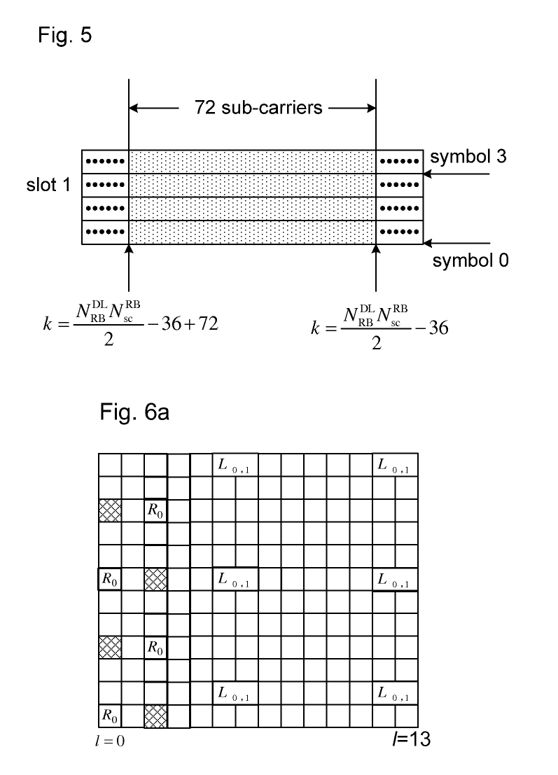

step 2: the sender performs resource mapping for the broadcast data according to the reference signal patterns of the service symbols and performs scrambling by using a configured common RNTI to ensure that all UEs can receive broadcast information. FIG. 5 shows a schematic diagram of the time-frequency resources occupied by the broadcast information. The data at this time-frequency location need to be configured to be received by all UEs;

step 3: the sender maps the control information to the control symbols according to the common reference signal pattern on the control symbols and applies virtual antenna transmit diversity or other transmit diversity schemes, such as

$$[ \begin{matrix}{s}_{1} & - {s}_{2}^{*} \\ {s}_{2} & {s}_{1}^{*} \\ {s}_{1} {e}^{j {θ}_{1}} & - {s}_{2}^{*} {e}^{j {θ}_{1}} \\ {s}_{2} {e}^{j {θ}_{2}} & {s}_{1}^{*} {e}^{j {θ}_{2}}\end{matrix} ] ;$$

step 4: the user-dedicated reference signals carried on the service symbols apply patterns of FDM access; and resource mapping is performed on the service data at the sender according to the reference signal patterns of two antenna ports (antenna port 0 and antenna port 1), as shown in FIG. 4a and FIG. 4b;

step 5: the UE receives the broadcast information according to a predetermined RNTI, acquires information related to antennas and bandwidth, determines the reference signal pattern of the control symbols according to the number of the antennas, and determines the number of downlink available resource blocks and the frequency resources of the whole bandwidth according to the bandwidth; as for the broadcast data, since the transmit diversity scheme is applied, the number of layers is not the number of separable layers of a spatial channel, but the number of antenna ports (or virtual ports) applied to the transmit diversity;

step 6: the UE detects the PCFICH on the first OFDM symbol and determines the number of the OFDM symbols for transmitting the control information; the UE detects its corresponding control information on corresponding OFDM symbols, including Downlink Control Information (DCI);

step 7: the UE performs channel estimation according to the reference signal patterns as shown in FIG. 4a and FIG. 4b and thus receives service data on a corresponding RB according to the received DCI.

### EXAMPLE 2

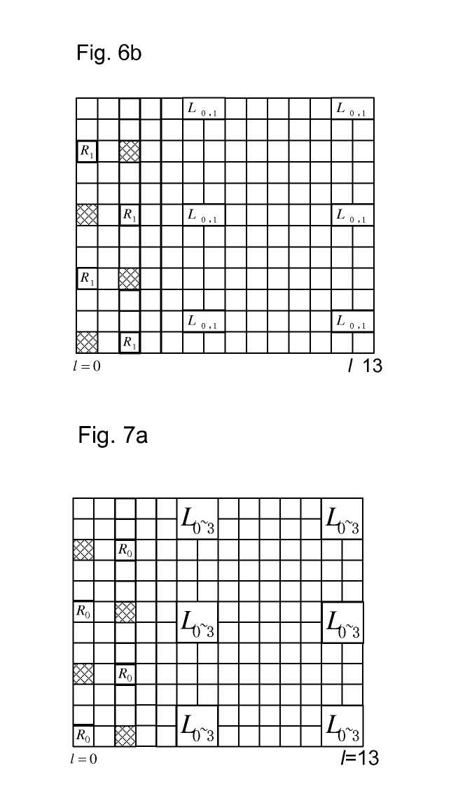

FIG. 6a shows a schematic diagram of a reference signal mapping pattern of antenna port 0, and FIG. 6b shows a schematic diagram of a reference signal mapping pattern of antenna port 1.

As shown in FIG. 6a, R₀ represents a common reference signal of antenna port 0, L_{0,1} represents a user-dedicated reference signal, the number of OFDM symbols for transmitting control information is 3, that is, the number of control symbols is 3, and the number of service symbols is 11, wherein the control symbols are OFDM symbols numbered with l=0, 1, 2 and the service symbols are OFDM symbols numbered with l=3-13. In addition, the user-dedicated reference signals L_{0,1} are used for demodulating broadcast data and service data of layer 0 and layer 1. Since the number of layers of the user-dedicated reference signals is configured the same as the number of channel layers for transmitting service data in the service channel, a base station transmits data of the service channel by using layer 0 and layer 1. In addition, it can be seen from FIG. 6a that the interval between neighboring user-dedicated reference signals on the same sub-carrier is 5 OFDM symbols. The minimal interval between user-dedicated reference signals on the same OFDM symbol or different OFDM symbols is 4 sub-carriers.

As shown in FIG. 6b, R₀ represents a common reference signal of antenna port 1, L_{0,1} represents a user-dedicated reference signal, the number of OFDM symbols for transmitting control information is 3, that is, the number of control symbols is 3, and the number of service symbols is 11, wherein the control symbols are OFDM symbols numbered with l=0, 1, 2 and the service symbols are OFDM symbols numbered with l=3-13. The user-dedicated reference signals L₀ and L₁ are used for demodulating broadcast data and service data of layer 0 and layer 1. The number of layers of the user-dedicated reference signals of antenna port 0 is 2. Since the number of layers of the user-dedicated reference signals is configured the same as the number of channel layers for transmitting service data in the service channel, the base station transmits data of the service channel by using layer 0 and layer 1. In addition, it can be seen from FIG. 6b that the interval between neighboring user-dedicated reference signals on the same sub-carrier is 5 OFDM symbols. The minimal interval between user-dedicated reference signals on the same OFDM symbol or different OFDM symbols is 4 sub-carriers.

In this example, the number of the OFDM symbols for transmitting control information is 3 and the number of layers for transmitting service data is 2 (antenna port 0 and antenna port 1 respectively use two layers of the service channel to transmit service data). The reference signals on service symbols are in the form of Code Division Multiplexing (CDM). The service data is transmitted in the manner of spatial multiplexing. The control information is transmitted in the manner of transmit diversity. The number of separable layers of a spatial channel corresponding to a UE is 2, and the data stream of the UE is mapped to the two transmission layers. The PCFICH notifies a current sub-frame that there are 3 OFDM symbols for transmitting control information. In this way, the specific steps for realizing reference signal configuration and demodulation are as follows:

step 1: a sender maps a reference signal sequence (common reference signals and user-dedicated reference signals) to corresponding time-frequency resources according to the reference signal patterns of FIG. 6a and FIG. 6b;

step 2: the sender performs resource mapping for the broadcast data according to the reference signal patterns of the service symbols and performs scrambling by using a configured common RNTI to ensure that all UEs can receive the broadcast information;

step 3: the sender maps the control information to the control symbols according to the common reference signal pattern on the control symbols and applies virtual antenna transmit diversity or other transmit diversity schemes, such as SFBC+FSTD:

$$[ \begin{matrix}{s}_{1} & - {s}_{2}^{*} & & & \\ {s}_{2} & {s}_{1}^{*} & & & \\ {s}_{1} {e}^{{jθ}_{1} k} & - {s}_{2}^{*} {e}^{{jθ}_{1} k} & & {0}_{4 x 2} & \\ {s}_{2} {e}^{{jθ}_{2} k} & {s}_{1}^{*} {e}^{{jθ}_{2} k} & & & \\ & & & {s}_{3} & - {s}_{4}^{*} \\ & {0}_{4 x 2} & & {s}_{4} & {s}_{3}^{*} \\ & & & {s}_{3} {e}^{{jθ}_{1}} & - {s}_{4}^{*} {e}^{{jθ}_{1}} \\ & & & {s}_{4} {e}^{{jθ}_{2}} & {s}_{3}^{*} {e}^{{jθ}_{2}}\end{matrix} ] ;$$

step 4: the user-dedicated reference signals carried on the service symbols apply the patterns of CDM access; as shown in FIG. 6a and FIG. 6b, the sender can perform corresponding precoding according to the number of layers allocated to the user and perform resource mapping according to the reference signal patterns of the service symbols;

step 5: the UE receives broadcast information according to a predetermined RNTI, acquires information related to antennas and bandwidth, determines the reference signal pattern of the control symbols according to the number of the antennas, and determines the number of downlink available resource blocks and the frequency resources of the whole bandwidth according to the bandwidth; as for the broadcast data, since the transmit diversity scheme is applied, the number of layers is not the number of separable layers of a spatial channel, but the number of antenna ports (or virtual ports) applied to the transmit diversity;

step 6: the UE detects the PCFICH on the first OFDM symbol and determines the number of the OFDM symbols for transmitting control information; the UE detects its corresponding control information on corresponding OFDM symbols, including DCI;

step 7: the UE performs channel estimation according to the reference signal patterns as shown in FIG. 6a and FIG. 6b, and receives the service data on corresponding RBs by using a Precoding Matrix Indicator (PMI) in the DCI according to the received DCI.

### EXAMPLE 3

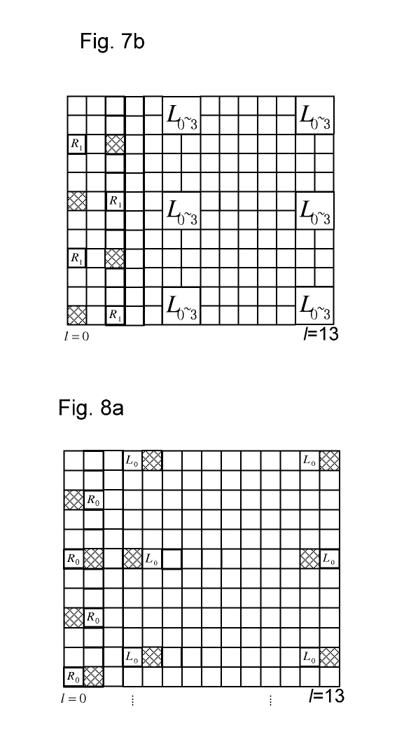

As shown in FIG. 7a, R₀ represents a common reference signal of antenna port 0, L_{0˜3} represents a user-dedicated reference signal, the number of OFDM symbols for transmitting control information is 3, that is, the number of control symbols is 4, and the number of service symbols is 11, wherein the control symbols are OFDM symbols of l=0, 1, 2 and the service symbols are OFDM symbols of l=3-13. In addition, L_{0˜3} further represents that layer 0, layer 1, layer 2 and layer 3 of the user-dedicated reference signals are used for demodulating broadcast data and service data, the number of layers of the user-dedicated reference signals of the antenna port 0 is 4. Since the number of layers of the user-dedicated reference signals is configured the same as the number of channel layers for transmitting service data in the service channel, a base station transmits data of the service channel by using layer 0, layer 1, layer 2 and layer 3. In addition, it can be seen from FIG. 7a that the interval between neighboring user-dedicated reference signals on the same sub-carrier is 5 OFDM symbols, and the minimal interval between user-dedicated reference signals on the same OFDM symbol or different OFDM symbols is 3 sub-carriers.

As shown in FIG. 7b, R₀ represents a common reference signal of antenna port 1, L_{0˜3} represents a user-dedicated reference signal, the number of OFDM symbols for transmitting control information is 3, that is, the number of control symbols is 4, and the number of service symbols is 11, wherein the control symbols are OFDM symbols numbered with l=0, 1, 2 and the service symbols are OFDM symbols numbered with l=3˜13. In addition, L_{0˜3} further represents that layer 0, layer 1, layer 2 and layer 3 of the user-dedicated reference signals are used for demodulating broadcast data and service data, the number of layers of the user-dedicated reference signals of the antenna port 0 is 4. Since the number of layers of the user-dedicated reference signals is configured the same as the number of channel layers for transmitting service data in the service channel, a base station transmits data of the service channel by using layer 0, layer 1, layer 2 and layer 3. In addition, it can be seen from FIG. 7b that the interval between neighboring user-dedicated reference signals on the same sub-carrier is 5 OFDM symbols, and the minimal interval between user-dedicated reference signals on the same OFDM symbol or different OFDM symbols is 3 sub-carriers.

In this example, the number of the OFDM symbols for transmitting control information is 3 and the number of layers for transmitting the service data is 4 (antenna port 0 and antenna port 1 respectively use 4 transmission layers to transmit the service data). The reference signals on the service symbols are in the form of code division multiplexing. For example, the number of transmitting antennas is 8, the service data is transmitted in the manner of spatial multiplexing, the control information and the broadcast information are transmitted in the manner of transmit diversity, there are 4 separable layers for the channel, the PCFICH notifies a current sub-frame that there are 3 OFDM symbols for transmitting the control information, in this way, the specific steps for realizing reference signal configuration and demodulation are as follows:

step 1: a sender maps a reference signal sequence (common reference signals and user-dedicated reference signals) to corresponding time-frequency resources according to the reference signal patterns of FIG. 7a and FIG. 7b;

step 2: the sender performs resource mapping for the broadcast data according to the reference signal patterns of the service symbols and performs scrambling by using a special RNTI to ensure that all UEs can receive the broadcast information;

step 3: the sender maps the control information to the control symbols according to the common reference signal pattern on the control symbols and applies virtual antenna transmit diversity or other transmit diversity schemes, such as SFBC+FSTD:

$$[ \begin{matrix}{s}_{1} & - {s}_{2}^{*} & & & \\ {s}_{2} & {s}_{1}^{*} & & & \\ {s}_{1} {e}^{{jθ}_{1} k} & - {s}_{2}^{*} {e}^{{jθ}_{1} k} & & {0}_{4 \times 2} & \\ {s}_{2} {e}^{{jθ}_{2} k} & {s}_{1}^{*} {e}^{{jθ}_{2} k} & & & \\ & & & {s}_{3} & - {s}_{4}^{*} \\ & {0}_{4 \times 2} & & {s}_{4} & {s}_{3}^{*} \\ & & & {s}_{3} {e}^{{jθ}_{1}} & - {s}_{4}^{*} {e}^{{jθ}_{1}} \\ & & & {s}_{4} {e}^{{jθ}_{2}} & {s}_{3}^{*} {e}^{{jθ}_{2}}\end{matrix} ] ;$$

step 4: the user-dedicated reference signals carried on the service symbols apply the patterns of CDM access; as shown in FIG. 7a and FIG. 7b, 4 resource elements (REs) are in the form of code division, and multiplex 4 layers of reference signals. In the figures, every square represents one RE. The sender can perform corresponding precoding according to the number of layers allocated to the user and perform resource mapping according to the reference signal patterns of the service symbols;

step 5: the UE receives broadcast information according to a predetermined RNTI, acquires information related to antennas and bandwidth, determines the reference signal pattern of the control symbols according to the number of the antennas, and determines the number of downlink available resource blocks and the frequency resources of the whole bandwidth according to the bandwidth; as for the broadcast data, since the transmit diversity scheme is applied, the number of layers is not the number of separable layers of a spatial channel, but the number of antenna ports (or virtual ports) applied to the transmit diversity;

step 6: the UE detects the PCFICH on the first OFDM symbol, determines the number of the OFDM symbols for transmitting control information, and determines reference signal patterns of control symbols; the UE detects its corresponding control information on the corresponding OFDM symbols according to the reference signal pattern, including DCI;

step 7: the UE performs channel estimation according to the reference signal patterns as shown in FIG. 7a and FIG. 7b, and receives the service data on corresponding RBs by using a PMI in the DCI according to the received DCI.

### EXAMPLE 4

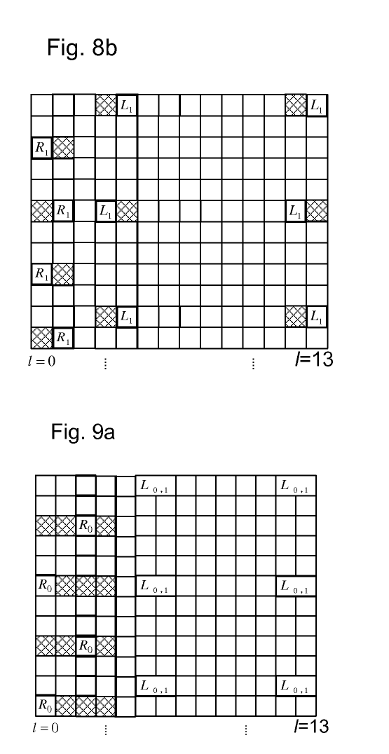

As shown in FIG. 8a, R₀ represents a common reference signal of antenna port 0, L₀ represents a user-dedicated reference signal, the number of OFDM symbols for transmitting control information is 2, that is, the number of control symbols is 2, and the number of service symbols is 12, wherein the control symbols are OFDM symbols numbered with l=0, 1 and the service symbols are OFDM symbols numbered with l=2-13. In addition, L₀ further represents the user-dedicated reference signal for demodulating broadcast data and service data. The antenna port 0 carriers the user-dedicated reference signal of layer 0. Since the number of layers of the user-dedicated reference signals is configured the same as the number of channel layers for transmitting the service data in the service channel, a base station transmits data of the service channel by using layer 0 and layer 1. In addition, it can be seen from FIG. 8a that the interval between neighboring user-dedicated reference signals on the same sub-carrier is 6 OFDM symbols, and the minimal interval between user-dedicated reference signals on the same OFDM symbol or different OFDM symbols is 4 sub-carriers.

As shown in FIG. 8b, R₁ represents a common reference signal of antenna port 1, L₁ represents a user-dedicated reference signal of the first layer, the number of OFDM symbols for transmitting control information is 2, that is, the number of control symbols is 2, and the number of service symbols is 12, wherein the control symbols are OFDM symbols numbered with l=0, 1 and the service symbols are OFDM symbols numbered with l=2-13. In addition, L₀ and L₁ are used for demodulating broadcast data and service data. The antenna port 1 carries the user-dedicated reference signal of the first layer. Since the number of layers of the user-dedicated reference signals is configured the same as the number of channel layers for transmitting service data in the service channel, a base station transmits service data by using the first layer 1 of the service channel. In addition, it can be seen from FIG. 8b that the interval between neighboring user-dedicated reference signals on the same sub-carrier is 6 OFDM symbols, and the minimal interval between user-dedicated reference signals on the same OFDM symbol or different OFDM symbols is 4 sub-carriers.

In this example, the number of the OFDM symbols for transmitting control information is 2 and the number of layers for transmitting service data is 2 (antenna port 0 and antenna port 1 respectively use one layer to transmit the service data). The reference signals on the service symbols are in the form of FDM. For example, the number of transmitting antennas is 4, the service data is transmitted in the manner of transmit diversity and the control information is transmitted in the manner of transmit diversity; there are 2 layers respectively for the service data and the broadcast data. This example is different from examples 1, 2 and 3 in that, the PCFICH notifies a current sub-frame that there are 2 OFDM symbols for transmitting control information. In this way, the specific steps for realizing reference signal configuration and demodulation are as follows:

step 1: a sender maps a reference signal sequence (common reference signals and user-dedicated reference signals) to corresponding time-frequency resources according to the reference signal patterns of FIG. 8a and FIG. 8b; since the value of the PCFICH is changed, the reference signal patterns of the control symbols and the reference signal patterns of the service symbols are changed, accordingly;

step 2: the sender performs resource mapping for the broadcast data according to the reference signal patterns of the service symbols, and performs scrambling by using special RNTI to ensure that all UEs can receive the broadcast information;

step 3: the sender maps the control information to the control symbols according to the common reference signal pattern on the control symbols and applies virtual antenna transmit diversity or other transmit diversity schemes, such as

$$[ \begin{matrix}{s}_{1} & - {s}_{2}^{*} \\ {s}_{2} & {s}_{1}^{*} \\ {s}_{1} {e}^{j {θ}_{1}} & - {s}_{2}^{*} {e}^{j {θ}_{1}} \\ {s}_{2} {e}^{j {θ}_{2}} & {s}_{1}^{*} {e}^{j {θ}_{2}}\end{matrix} ] ;$$

step 4: the user-dedicated reference signals carried on the service symbols apply the patterns of FDM access; and resource mapping is performed on the service data at the sender according to the reference signal patterns of two antenna ports (antenna port 0 and antenna port 1), as shown in FIG. 8a and FIG. 8b;

step 5: the UE receives broadcast information according to a predetermined RNTI, acquires information related to antennas and bandwidth, determines a reference signal pattern of the control symbols according to the number of the antennas, and determines the number of downlink available resource blocks and the frequency resources of the whole bandwidth according to the bandwidth; as for the broadcast data, since the transmit diversity scheme is applied, the number of layers is not the number of separable layers of a spatial channel, but the number of antenna ports (or virtual ports) applied to the transmit diversity;

step 6: the UE detects the PCFICH on the first OFDM symbol and determines the number of OFDM symbols for transmitting control information; the UE detects its corresponding control information on the corresponding OFDM symbols, including DCI;

step 7: the UE performs channel estimation according to the reference signal patterns as shown in FIG. 8a and FIG. 8b, and receives the service data on corresponding RBs by using an algorithm for receiving transmit diversity according to the received DCI.

### EXAMPLE 5

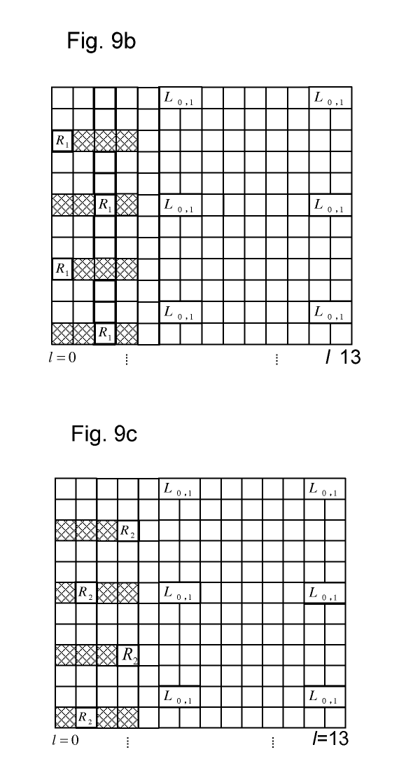

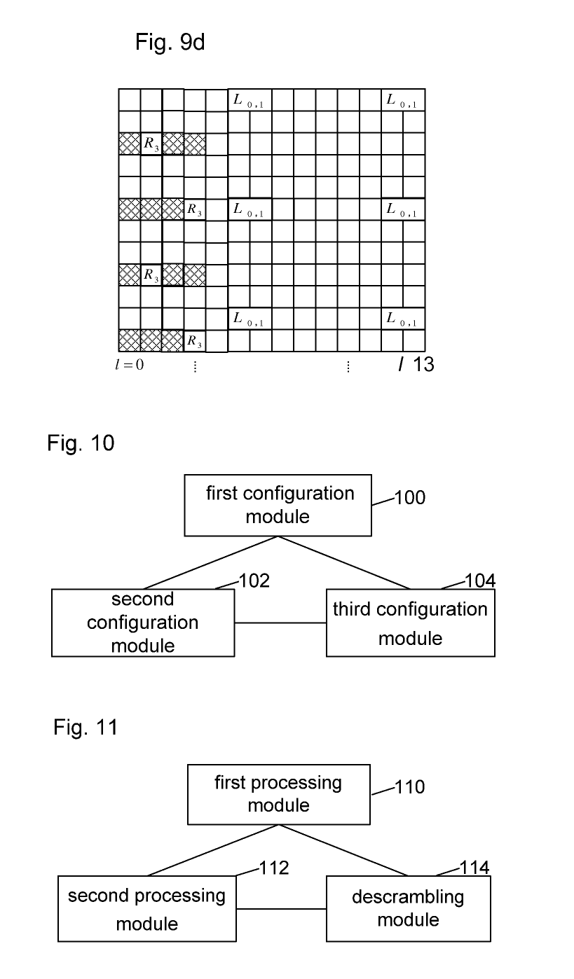

As shown in FIG. 9a, R₀ represents a common reference signal of antenna port 0, L_{0,1} represents a user-dedicated reference signal. In one RB, the number of OFDM symbols for transmitting control information is 4, that is, the number of control symbols is 4, and the number of service symbols is 10, wherein the control symbols are OFDM symbols numbered with l=0, 1, 2, 3 and the service symbols are OFDM symbols numbered with l=4-13. In addition, the user-dedicated reference signal L_{0,1} is used for demodulating broadcast data and service data. The antenna port 0 carries user-dedicated reference signals of two layers. It can be seen from FIG. 9a that the interval between neighboring user-dedicated reference signals on the same sub-carrier is 5 OFDM symbols, and the minimal interval between user-dedicated reference signals on the same OFDM symbol or different OFDM symbols is 4 sub-carriers.

As shown in FIG. 9b, R₁ represents a common reference signal of antenna port 1, L_{0,1} represents a user-dedicated reference signal, the number of OFDM symbols for transmitting control information is 4, that is, the number of control symbols is 4, and the number of service symbols is 10, wherein the control symbols are OFDM symbols numbered with l=0, 1, 2, 3 and the service symbols are OFDM symbols numbered with l=4-13. In addition, the user-dedicated reference signal L_{0,1} is used for demodulating broadcast data and service data. In addition, it can be seen from FIG. 9b that the interval between neighboring user-dedicated reference signals on the same sub-carrier is 5 OFDM symbols, and the minimal interval between user-dedicated reference signals on the same OFDM symbol or different OFDM symbols is 4 sub-carriers.

As shown in FIG. 9c, R₂ represents a common reference signal of antenna port 2, L_{0,1} represents a user-dedicated reference signal, the number of OFDM symbols for transmitting control information is 4, that is, the number of control symbols is 4, and the number of service symbols is 10, wherein the control symbols are OFDM symbols numbered with l=0, 1, 2, 3 and the service symbols are OFDM symbols numbered with l=4-13. In addition, the user-dedicated reference signal L_{0,1} is used for demodulating broadcast data and service data. In addition, it can be seen from FIG. 9c that the interval between neighboring user-dedicated reference signals on the same sub-carrier is 5 OFDM symbols, and the minimal interval between user-dedicated reference signals on the same OFDM symbol or different OFDM symbols is 4 sub-carriers.

As shown in FIG. 9d, R₃ represents a common reference signal of antenna port 3, L_{0,1} represents a user-dedicated reference signal, the number of OFDM symbols for transmitting control information is 4, that is, the number of control symbols is 4, and the number of service symbols is 10, wherein the control symbols are OFDM symbols numbered with l=0, 1, 2, 3 and the service symbols are OFDM symbols numbered with l=4-13. In addition, the user-dedicated reference signal L_{0,1} is used for demodulating broadcast data and service data. In addition, it can be seen from FIG. 9d that the interval between neighboring user-dedicated reference signals on the same sub-carrier is 5 OFDM symbols, and the minimal interval between user-dedicated reference signals on the same OFDM symbol or different OFDM symbols is 4 sub-carriers.

In this example, the number of the OFDM symbols for transmitting control information is 4 and the number of layers for transmitting service data is 2 (antenna port 0 and antenna port 1 respectively use 2 transmission channel layers to transmit the service data). The reference signals on the service symbols are in the form of CDM. For example, the number of transmitting antennas is 8, the service data is transmitted in the manner of spatial multiplexing and the control information is transmitted in the manner of transmit diversity; there are 2 separable layers of a spatial channel corresponding to a UE, and the data stream of the UE is mapped to the two transmission layers; the PCFICH notifies a current sub-frame that there are 4 OFDM symbols for transmitting control information. In this way, the specific steps for realizing reference signal configuration and demodulation are as follows:

step 1: a sender maps a reference signal sequence (common reference signals and user-dedicated reference signals) to corresponding time frequency resources according to the reference signal patterns of FIG. 9a, FIG. 9b, FIG. 9c and FIG. 9d;

step 2: the sender performs resource mapping for the broadcast data according to the reference signal patterns of the service symbols, and performs scrambling by a configured common RNTI to ensure that all UEs can receive the broadcast information;

step 3: the sender maps the control information to the control symbols according to the common reference signal pattern on the control symbols and applies virtual antenna transmit diversity or other transmit diversity schemes, such as SFBC+FSTD:

$$[ \begin{matrix}{s}_{1} & - {s}_{2}^{*} & & & \\ {s}_{2} & {s}_{1}^{*} & & & \\ {s}_{1} {e}^{{jθ}_{1} k} & - {s}_{2}^{*} {e}^{{jθ}_{1} k} & & {0}_{4 \times 2} & \\ {s}_{2} {e}^{{jθ}_{2} k} & {s}_{1}^{*} {e}^{{jθ}_{2} k} & & & \\ & & & {s}_{3} & - {s}_{4}^{*} \\ & {0}_{4 \times 2} & & {s}_{4} & {s}_{3}^{*} \\ & & & {s}_{3} {e}^{{jθ}_{1}} & - {s}_{4}^{*} {e}^{{jθ}_{1}} \\ & & & {s}_{4} {e}^{{jθ}_{2}} & {s}_{3}^{*} {e}^{{jθ}_{2}}\end{matrix} ] ;$$

step 4: the user-dedicated reference signals carried on the service symbols apply the patterns of CDM access; and as shown in FIG. 6a and FIG. 6b, the sender can perform corresponding precoding according to the layers allocated to the user and perform resource mapping according to the reference signal patterns of the service symbols;

step 5: the UE receives broadcast information according to a predetermined RNTI, acquires information related to antennas and bandwidth, determines a reference signal pattern of the control symbols according to the number of the antennas, and determines the number of downlink available resource blocks and the frequency resources of the whole bandwidth according to the bandwidth; as for the broadcast data, since the transmit diversity scheme is applied, the number of layers is not the number of separable layers of a spatial channel, but the number of antenna ports (or virtual ports) applied to the transmit diversity;

step 6: the UE detects the PCFICH on the first OFDM symbol and determines the number of OFDM symbols for transmitting control information; the UE detects its corresponding control information on the corresponding OFDM symbols, including DCI;

step 7: the UE performs channel estimation according to the reference signal patterns as shown in FIG. 9a, FIG. 9b, FIG. 9c and FIG. 9d and receives the service data on corresponding RBs by using a PMI in the DCI according to the received DCI.

FIG. 10 shows a structure block diagram of a base station according to an embodiment of the present disclosure. As shown in FIG. 10, the base station comprises:

a first configuration module 100 for configuring common reference signals on control symbols, wherein the pattern of the common reference signals may be a current reference signal pattern of all antenna ports in the prior art;

a second configuration module 102 for configuring user-dedicated reference signals on service symbols, and making a broadcast channel and a service channel carried on the service symbols, wherein the broadcast channel is used for transmitting broadcast information and the service channel is used for transmitting service data, wherein the control symbols are OFDM symbols carrying control information and the service symbols are OFDM symbols without carrying control information. When the second configuration module 102 configures user-dedicated reference signals on the service symbols, the following configuration rules may be applied: the interval between neighboring user-dedicated reference signals on the same sub-carrier is N OFDM symbols, wherein N=4, 5, 6 or 7; the minimal interval between user-dedicated reference signals on the same or different OFDM symbols is M sub-carriers, wherein M=3 or 4. Here, only the relative locations of all user-dedicated reference signals are specified, and every specific downlink-dedicated location can be flexibly configured according to the need, as long as the relative locations of all user-dedicated reference signals satisfy the aforementioned rules. In addition, the number of layers of the user-dedicated reference signals is configured the same as the number of channel layers for transmitting service data in the service channel.

Preferably, the base station may further comprise a third configuration module 104 for configuring a channel identifier for the broadcast channel, and sending the channel identifier to the base station and a user, wherein the channel identifier can be scrambled by the base station. For example, the channel identifier may be a radio network temporary identifier.

FIG. 11 shows a structure block diagram of a user equipment according to an embodiment of the present disclosure. As shown in FIG. 11, the UE comprises:

a first processing module 110 for demodulating control information by using common reference signals configured on control symbols;

a second processing module 112 for demodulating service data and broadcast data by using user-dedicated reference signals configured on service symbols; wherein the control symbols are OFDM symbols carrying control information and the service symbols are OFDM symbols without carrying control information.

Preferably, the UE further comprises a descrambling module 114 for descrambling a channel identifier of the broadcast channel carried on the service symbols to receive broadcast information.

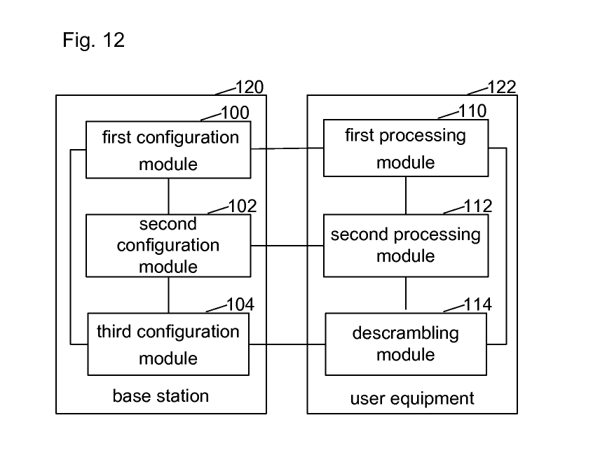

According to the processing method of demodulate reference signal described above, a processing system of demodulate reference signal of the present disclosure is as shown in FIG. 12, comprising a base station 120 and a UE 122, wherein the base station 120 may be the base station as shown in FIG. 10 and the UE 122 may be the UE as shown in FIG. 11. Therefore, it is unnecessary to go into details here.

FIG. 10 and FIG. 11 show the devices corresponding to the aforementioned methods. The working process and working principles of the devices are described in details in the methods, which can refer to the description of the corresponding parts in the methods. Therefore, it is unnecessary to go into details here.

In conclusion, with the aforementioned technical solution of the present disclosure, the objective of reducing the overhead of reference signals can be achieved by respectively designing the reference signals on the service symbols and that on the control symbols. In addition, the reference signals on the broadcast channel and the reference signals on the service channel are designed uniformly, so that the design of the reference signals on the service symbols is simplified, and the overhead of reference signals is reduced while the transmit diversity performance is not evidently reduced for the virtual antenna mapping technology. Further, since this disclosure relates to the design of a demodulate reference signal (DMRS) in the multi-antenna communication system, the present disclosure can be applied to a multiple input multiple output system (MIMO) with multiple transmitting antennas.

What are described above are only preferred embodiments of the present disclosure and are not for use in limiting the present disclosure. Any modification, equivalent replacement and improvement made within the principle of the present disclosure should be included in the protection scope of the present disclosure.

1. A configuring method of demodulate reference signal, comprising:
configuring, by a base station, common reference signals on control symbols and user-dedicated reference signals on service symbols;
wherein the control symbols are Orthogonal Frequency Division Multiplexing (OFDM) symbols carrying control information, and the service symbols are OFDM symbols without carrying control information.

2. The method according to claim 1, further comprising:
making, by the base station, a control channel for transmitting the control information carried on the control symbols.

3. The method according to claim 1, wherein an interval between neighboring user-dedicated reference signals on a same sub-carrier is N OFDM symbols, wherein N is 4, 5, 6 or 7;
a minimal interval between user-dedicated reference signals on a same OFDM symbol or different OFDM symbols is M sub-carriers, wherein M=3 or 4.

4. The method according to claim 1, further comprising:
making, by the base station, a broadcast channel for transmitting broadcasting information and a service channel for transmitting service data carried on the service symbols.

5. The method according to claim 4, further comprising: when configuring the user-dedicated reference signals on the service symbols, configuring a number of layers of the user-dedicated reference signals as same as a number of channel layers for transmitting the service data in the service channel to obtain layered user-dedicated reference signals; and using the layered user-dedicated reference signals to demodulate the service data and the broadcast information.

6. The method according to claim 3, further comprising:
configuring, by the base station, a channel identifier for the broadcast channel, wherein the channel identifier can be scrambled by the base station.

7. The method according to claim 6, wherein the channel identifier is a radio network temporary identifier.

8. A demodulating method of demodulate reference signal, comprising:
demodulating, by a UE, control information by using common reference signals configured on control symbols, and demodulating service data and broadcast data by using user-dedicated reference signals configured on service symbols;
wherein the control symbols are OFDM symbols carrying control information and the service symbols are OFDM symbols without carrying control information.

9. The method according to claim 8, further comprising:
using, by the UE, a channel identifier of a broadcast channel to descramble broadcast information carried on the service symbols to receive the broadcast information.

10. A processing method of demodulate reference signal, comprising:
configuring, by a base station, common reference signals on control symbols and user-dedicated reference signals on service symbols;
demodulating, by a UE, control information by using the common reference signals and demodulating service data and broadcast data by using the user-dedicated reference signals;
wherein the control symbols are OFDM symbols carrying control information and the service symbols are OFDM symbols without carrying control information.

11. A base station, comprising:
a first configuration module for configuring common reference signals on control symbols;
a second configuration module for configuring user-dedicated reference signals on service symbols, and making a broadcast channel and a service channel carried on the service symbols, wherein the broadcast channel is configured to transmit broadcast information and the service channel is configured to transmit service data;
wherein the control symbols are OFDM symbols carrying control information and the service symbols are OFDM symbols without carrying control information.

12. The base station according to claim 11, wherein an interval between neighboring user-dedicated reference signals on a same sub-carrier is N OFDM symbols, wherein N=4, 5, 6 or 7;
a minimal interval between user-dedicated reference signals on a same OFDM symbol or different OFDM symbols is M sub-carriers, wherein M=3 or 4.

13. A UE, comprising:
a first processing module for demodulating control information by using common reference signals configured on control symbols;
a second processing module for demodulating service data and broadcast information by using user-dedicated reference signals configured on service symbols;
wherein the control symbols are OFDM symbols carrying control information and the service symbols are OFDM symbols without carrying control information.

14. A processing system of demodulate reference signal, comprising a base station and a UE,
wherein the base station is configured to configure common reference signals on control symbols and user-dedicated reference signals on service symbols, and the base station comprises:
a first configuration module for configuring the common reference signals on the control symbols;
a second configuration module for configuring the user-dedicated reference signals on the service symbols, and making a broadcast channel and a service channel carried on the service symbols;
the UE is configured to demodulate control information by using the common reference signals, and to demodulate service data and broadcast data by using the user-dedicated reference signals, and the UE comprises:
a first processing module for demodulating the control information by using the common reference signals configured on the control symbols;
a second processing module for demodulating the service data and broadcast information by using the user-dedicated reference signals configured on the service symbols;
wherein the control symbols are OFDM symbols carrying control information and the service symbols are OFDM symbols without carrying control information.
